(19) United States
(12) Patent Application Publication
(10) Pub. No.: US 2008/0084697 A1
(43) Pub. Date: Apr. 10, 2008

(54) Reflector Assembly and Method for Improving the Optical Efficiency of a Lighting Fixture

(76) Inventor: Victor Eberhard, Darien, IL (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/539,829

(22) Filed: Oct. 9, 2006

(51) Int. Cl. F21V 7/00

(52) U.S. Cl. 362/297; 362/346

(57) ABSTRACT

A reflector assembly is provided for use in a lighting fixture. The reflector assembly includes a primary reflector adapted to mate to the lighting fixture and including a first inner surface having a first reflectivity value and a secondary reflector disposed within the primary reflector and including a second inner surface having a second reflectivity value that is greater than the first reflectivity value. In one implementation, the secondary reflector is formed from a pre-finished material having the second inner surface, where the second reflectivity of the second inner surface is equal to or greater than 95 percent.

### FIELD OF THE INVENTION

The invention relates to a lighting fixture and, more particularly, to a reflector assembly for use in a lighting fixture in which the reflector assembly includes a primary reflector having a first reflectivity value and a secondary reflector disposed within the primary reflector and having a second reflectivity value greater than the first reflectivity value.

### BACKGROUND OF THE INVENTION

Conventional reflectors for lighting fixtures or luminaries have been designed for many years as a single piece element. More recently, two piece reflectors have been manufactured for lighting fixtures, in which the first reflector is attached to or part of the housing of the lighting fixture so that the first reflector is disposed at least partially above a lamp or lamp package of the lighting fixture. The second reflector (which is often part of a finishing trim) is typically attached below the first reflector to become the effective aperture of the fixture. To achieve a specular reflective finish on an interior surface of a conventional single piece reflector or a conventional multiple piece reflector, the respective conventional reflector typically undergoes a surface preparation process in which the interior surface of the respective reflector is polished after it is pre-formed into its final shape. One disadvantage of this surface preparation process is that the resulting reflectivity of the respective reflector is limited to the pre-formed shape of the respective reflector. For example, bending, stamping, deep drawing of an unfinished aluminum sheet to form the shape of a reflector often results in substantially decreased surface uniformity, which typically impacts the reflectance value that may be achieved via an anodizing process and adds to the manufacturing cost of the reflector.

After undergoing the conventional surface preparation process, the interior surface of the reflector is typically anodized using a conventional electrochemical, electroplating or electropolishing technique, such as the industry standard Alzak™ process, to produce a specular reflective finish. The reflectivity of the finish produced by conventional electrochemical, electroplating or electropolishing techniques depends on the purity of the aluminum substrate material used to produce the reflector. A pre-formed reflector produced from a “Reflector Grade” material (such 99.7% pure aluminum material) and anodized using a conventional electrochemical, electroplating or electropolishing process (such as the Alzak™ process) may have a surface finish with a reflectivity value up to 87 percent.

A “Reflector Grade” material is commercially available in a flat stock that has a pre-finished surface generated using an anodizing process that produces several nanometer-thin optical coatings (e.g., coatings of 99.9% pure aluminum material bonded on an aluminum substrate) to achieve a reflectivity value up to 95%. For example, one such flat stock “Reflector Grade” material with a pre-finished surface having up to 95% reflectivity is the MIRO® pre-finished material commercially available from the Alanod Company. However, there is a problem in using flat stock “Reflector Grade” material with a pre-finished surface to form a conventional reflector. Since the material has already been pre-treated or anodized to form multiple nanometer thin optical coatings to achieve a 95% reflectance value, the material typically may not be subjected to various standard reflector shape formation processes (e.g. hydroforming, deep draw, spinning about a chuck or die, etc.) without causing the pre-finished surface to crack or craze, degrading the quality of the material's pre-finished surface and negatively impacting the reflector's optical performance and reflectance value. In particular, “Reflector Grade” material with a pre-finished surface typically may not be bent in more than one linear direction without cracking or crazing occurring.

Therefore, a need exists for a lighting fixture having a reflector with improved optical efficiency that overcomes the problems noted above and others previously experienced for using a material having a pre-finished surface to form the lighting fixture reflector. These and other needs addressed by a lighting fixture consistent with the present invention will become apparent to those of skill in the art after reading the present specification.

### SUMMARY OF THE INVENTION

The foregoing problems are solved and a technical advance is achieved by the present invention. In accordance with articles of manufacture consistent with the present invention, a reflector assembly for use in a lighting fixture is provided. The reflector assembly comprises a primary reflector adapted to mate to the lighting fixture and including a first inner surface having a first reflectivity value. The reflector assembly further includes a secondary reflector disposed within the primary reflector and including a second inner surface having a second reflectivity value that is greater than the first reflectivity value. In one implementation, the secondary reflector is formed from a pre-finished material having the second inner surface, where the second reflectivity of the second inner surface is equal to or greater than 95 percent.

In accordance with methods consistent with the present invention, a method for improving the optical efficiency of a light fixture is provided. The light fixture has a primary reflector adapted to mate to the lighting fixture and includes a first inner surface having a first reflectivity value. The method comprises forming a secondary reflector having a second reflectivity value that is greater than the first reflectivity value of the primary reflector, and disposing the secondary reflector in proximity to the first inner surface of the primary reflector. In one implementation, the first inner surface of the primary reflector has a finish formed via an anodizing technique such that the first reflectivity value of the first inner surface of the primary reflector is equal to or less than 87 percent. In this implementation, the secondary reflector may be formed from a pre-finished material having the second inner surface, where the second reflectivity of the second inner surface is equal to or greater than 95 percent.

Other systems, assemblies, methods, features, and advantages of the present invention will be or will become apparent to one with skill in the art upon examination of the following figures and detailed description. It is intended that all such additional systems, assemblies, methods, features, and advantages be included within this description, be within the scope of the invention, and be protected by the accompanying claims.

### BRIEF DESCRIPTION OF THE DRAWINGS

The accompanying drawings, which are incorporated in and constitute a part of this specification, illustrate an implementation of the present invention and, together with the description, serve to explain the advantages and principles of the invention. In the drawings:

FIG. 1 is a exploded perspective view with a cutaway portion of one embodiment of a lighting fixture having a reflector assembly consistent with the present invention, where the reflector assembly includes a primary reflector and a secondary reflector disposed within the primary reflector;

FIG. 2 is a perspective view of the lighting fixture of FIG. 1 with a cutaway portion of a lamp package disposed at an angle relative to a vertical axis of the primary reflector and below the secondary reflector;

FIG. 3 is a side view of the lighting fixture of FIG. 1 with a cutaway portion of the lamp package disposed at an angle relative to a vertical axis of the primary reflector and at least partially below the secondary reflector;

FIG. 4 is a cross-sectional view of the secondary reflector in FIG. 1;

FIG. 5A is a comparison table depicting the candlepower and lumens output from the lighting fixture of FIG. 1 at various angles relative to a vertical axis of the lighting fixture with and without the secondary reflector disposed within the primary reflector;

FIG. 5B is a comparison polar graph that graphically depicts the candlepower or light intensity output as identified in the Table in FIG. 5A for the lighting fixture of FIG. 1 with and without the secondary reflector disposed within the primary reflector;

FIG. 5C is a summary comparison table depicting the percentage of lamp lumens (or light) reflected out of the lighting fixture of FIG. 1 with and without the secondary reflector disposed within the primary reflector;

FIG. 6 is a cross-sectional exploded side view of another embodiment of a reflector assembly consistent with the present invention suitable for use in a light fixture in which a lamp package is disposed along a vertical axis of the primary reflector and at least partially below the secondary reflector;

FIG. 7 is another cross-sectional side view of the reflector assembly of FIG. 6;

FIG. 8 is a cross-sectional exploded side view of yet another embodiment of a reflector assembly consistent with the present invention suitable for use in a light fixture in which a lamp package is disposed along a vertical axis of the primary reflector and at least partially below the secondary reflector; and

FIG. 9 is another cross-sectional side view of the reflector assembly of FIG. 8

### DETAILED DESCRIPTION OF THE INVENTION

Reference will now be made in detail to an implementation consistent with the present invention as illustrated in the accompanying drawings. Wherever possible, the same reference numbers will be used throughout the drawings and the following description to refer to the same or like parts. As would be understood to one of ordinary skill in the art, certain components or elements for installation of a light fixture (e.g., building support members, hanger arms, junction box, or electrical connections) are not shown in the figures or specifically noted herein to avoid obscuring the invention.

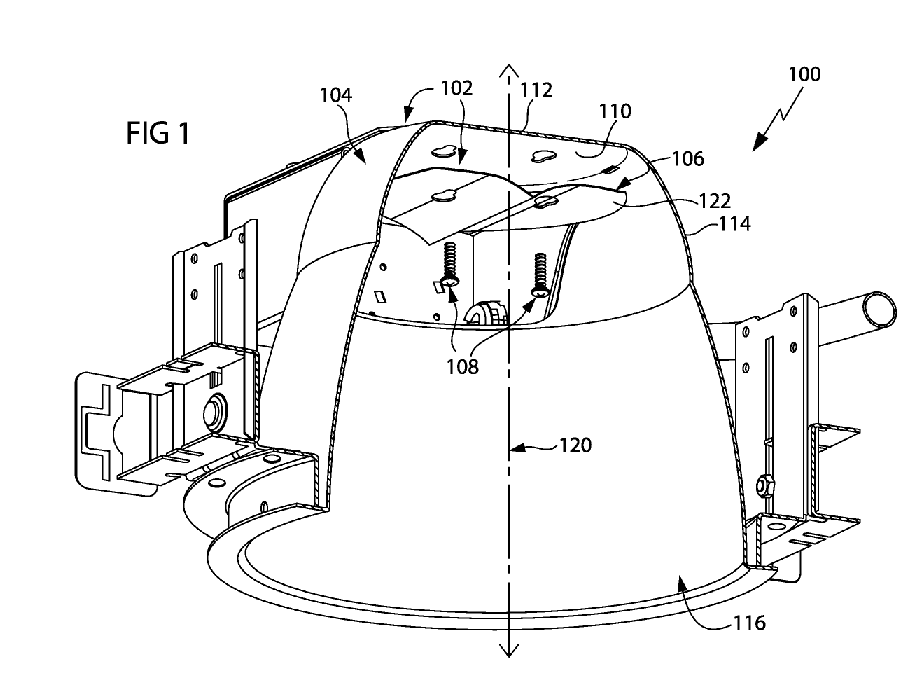

FIGS. 1-3 depict one embodiment of a lighting fixture 100 having a reflector assembly 102 consistent with the present invention. The reflector assembly 102 includes a primary reflector 104 and a secondary reflector 106. The primary reflector 104 is adapted to mate to the lighting fixture 100 using fasteners 108, tabs and keyholes (not shown in figures) or other known mating technique. Alternatively, the primary reflector 104 may be permanently affixed (e.g., welded) or integrally formed to the lighting fixture 100. The primary reflector 104 is pre-formed to have a final shape, such as a cylindrical shape, a conical shape, a bell shape or another shape adapted to allow light out of the light fixture. The primary reflector 104 may include or be made from aluminum or other material that may be pre-formed into the final shape of the reflector 104 using standard fabrication processes (e.g., hydroforming, deep draw, spinning about a chuck or die, or other process) and then polished and anodized using a standard anodizing technique (such as an ALZAK™ anodizing technique) so that an inner surface 110 of the primary reflector 104 has a specular finish with a reflectivity value up to 87%.

In the implementation shown in FIGS. 1-3, the primary reflector 104 has a top wall 112 having the first inner surface 110 and a side wall 114 extending from the top wall 112 and defining an open end 116 of the primary reflector 104. The primary reflector 104 may be pre-formed so that the inner surface 110 of the reflector 104 integrally extends from the top wall 112 down along the side wall 114 towards the open end 116 of the reflector. In this implementation, the inner surface 110 of the top wall 112 and side wall 114 may be polished and anodized to have a specular finish with a reflectivity value up to 87%.

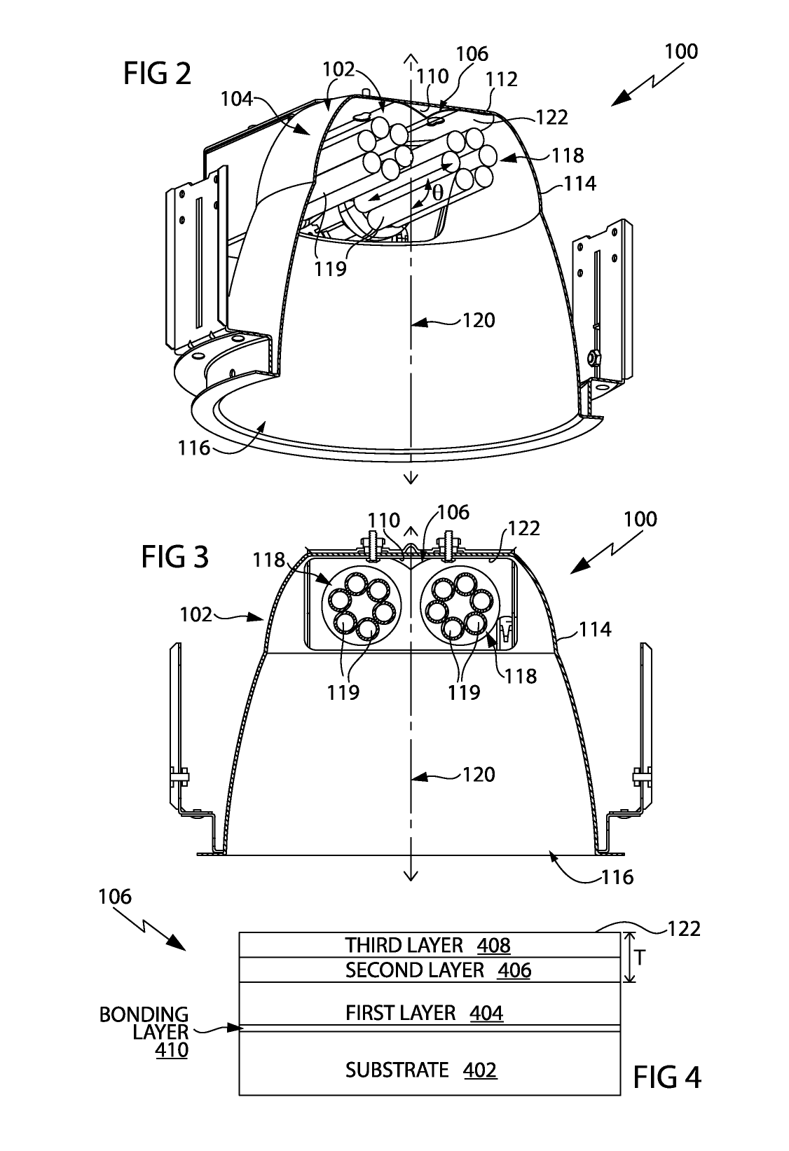

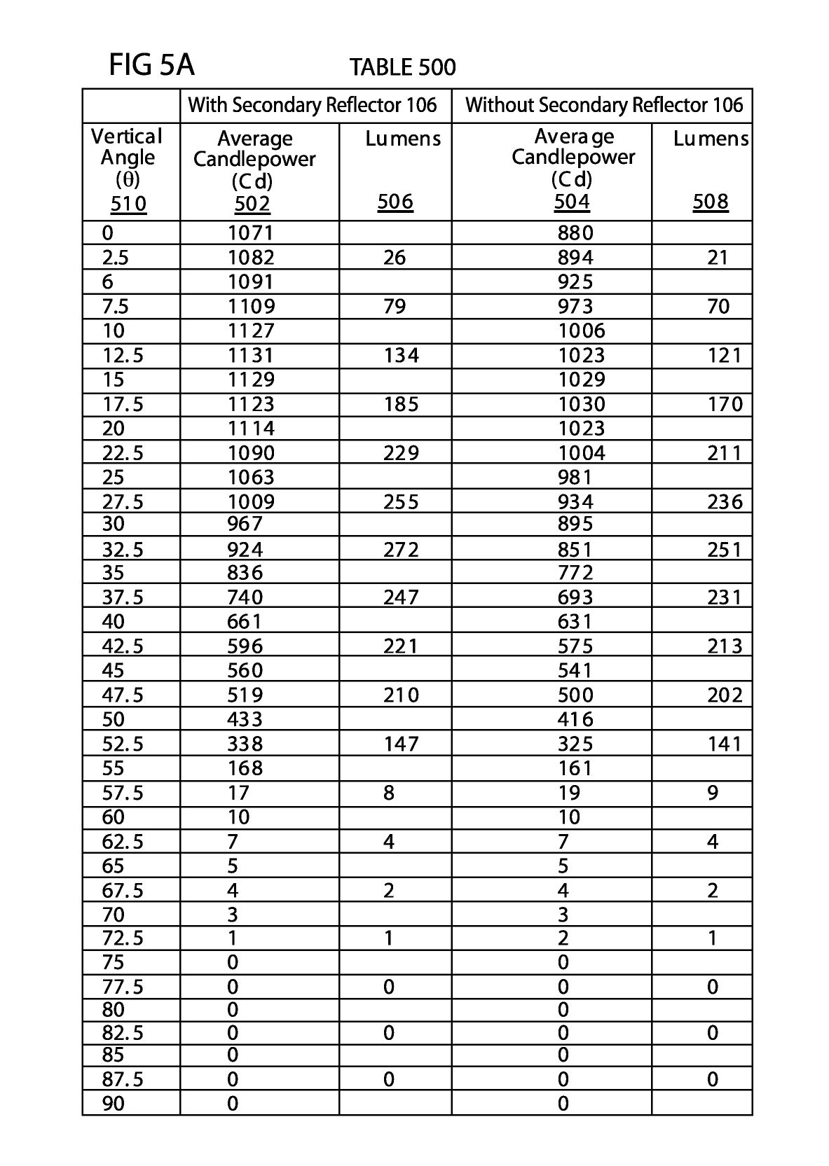

As shown in FIGS. 2-3, the primary reflector 104 is adapted to receive a lamp package 118 having one or more lamps 119, such that the lamp package 118 is disposed at least partially within and at an angle (θ) relative to a vertical axis 120 of the primary reflector 102. In the implementation shown in FIGS. 2-3, the lamp package 18 is disposed substantially perpendicular to the vertical axis 120 of the primary reflector 104.

The secondary reflector 106 has a second inner surface 122, which has a second reflectivity value that is greater than the first reflectivity value of the first inner surface 110 of the primary reflector 104. In one implementation, the secondary reflector 106 is formed from a pre-finished material, such as a MIRO® material commercially available from Alanod Aluminum-Veredlung GmbH & Co. KG, that has a specular surface (i.e., the second inner surface 122) with a reflectivity equal to or greater than 95 percent before and after the formation of the secondary reflector 106.

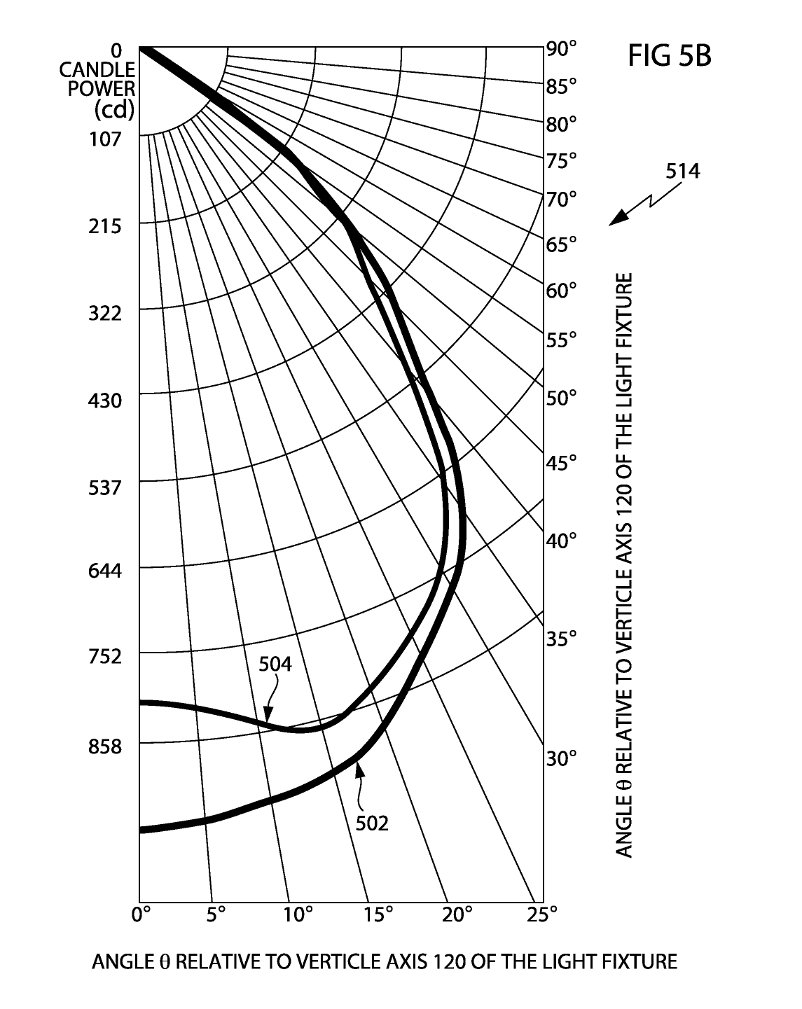

In one implementation of the secondary reflector 106 shown in cross-sectional view in FIG. 4, the pre-finished material (from which the secondary reflector 106 is formed and having the specular inner surface 122) comprises an anodized aluminum substrate 402, a first layer 404 formed over the substrate 402 that includes aluminum of 99.7% or greater purity, a second layer 406 formed over the first layer 404 that includes Silicium, and a third layer 408 formed over the second layer 406 that includes Titanium. The first layer 404 may be bonded to the substrate via a bonding layer 410.

The second layer 406 and the third layer 408 are each formed to have a respective thickness and a different refractive index such that light having a wavelength within the visible bandwidth that is directed toward the surface 122 of the third layer 408 is reflected by either the third layer 406, the third layer 408 in combination with the second layer 406, or the first layer 404 in combination with the second layer 406 and the third layer 408. In this implementation, the collective optical thickness (T) of the second layer 406 and the third layer 408 is approximately 80 nm or less.

To avoid cracking or crazing of the second inner surface 122 and degradation of the 95% or greater reflectivity of the specular inner surface 122 during formation of the secondary reflector, the secondary reflector 106 is preferably stamped or formed into a shape using standard fabrication process that does not require stretching or folding the pre-finished material in more than one direction simultaneously. Accordingly, the final shape of the secondary reflector 106 is preferably not formed using hydroforming, deep draw, spinning about a chuck or die, or other process that requires the second inner surface 122 to be stretched or folded in more than one direction substantially simultaneously.

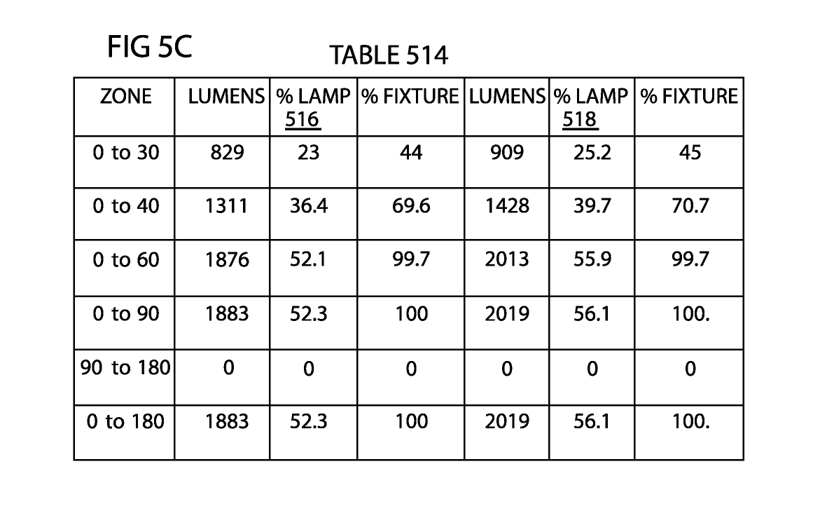

To assess the advantages of using the secondary reflector 106 within the primary reflector 104 to increase lamp light reflectance out of the light fixture 100, the inventors measured candlepower and lumens output from the open end 116 of the primary reflector 104 of the light fixture 100 using the same lamp package 118 with and without the secondary reflector 106 installed in accordance with the present invention. FIG. 5A is a comparison table 500 depicting the candlepower 502, 504 and lumens 506, 508 output from the lighting fixture 100 at various angles (θ) 510 relative to the vertical axis 120 of the lighting fixture 100 with and without the secondary reflector 106 disposed within the primary reflector 104. FIG. 5B is a comparison polar graph 512 that graphically depicts the candlepower or light intensity output 502 and 504 from the lighting fixture of FIG. 1 at the various angles (θ) 510 relative to the vertical axis 120 of the lighting fixture 100 with and without the secondary reflector 106 disposed within the primary reflector 104. As shown in Table 500 and depicted in the comparison polar graph 512, the candlepower 502 and lumens output 506 from the lighting fixture 100 with the secondary reflector 106 disposed within the primary reflector 104 is substantially greater than the candlepower 504 and lumens output 508 from the lighting fixture 100 without the secondary reflector 106 disposed within the primary reflector 104 at angles (θ) between 0° and 60° relative to the vertical axis 120 of the lighting fixture 100.

FIG. 5C is a summary comparison table 514 depicting the percentage of lamp lumens or light 516, 518 reflected out of the lighting fixture 100 with and without the secondary reflector 106 disposed within the primary reflector 104. As shown in table 514, The lamp light reflectance efficiency 522 corresponds to the difference in lamp lumens output percentage 516 and 518 for each zone 520 defined by vertical angles (θ) identified in FIGS. 5A-5B. In the implementation shown in FIG. 5C, the total lamp light reflectance efficiency 524 for the lamp fixture 100 is approximately 3.8%, which corresponds to the total increase in lamp lumens exiting the open end 116 of the primary reflector 104 of the light fixture 100 (the zone 526 between angles (θ) 0° and 180° relative to the vertical axis 120 of the lighting fixture 100) when the secondary reflector 106 is disposed within the primary reflector 104 in accordance with the present invention.

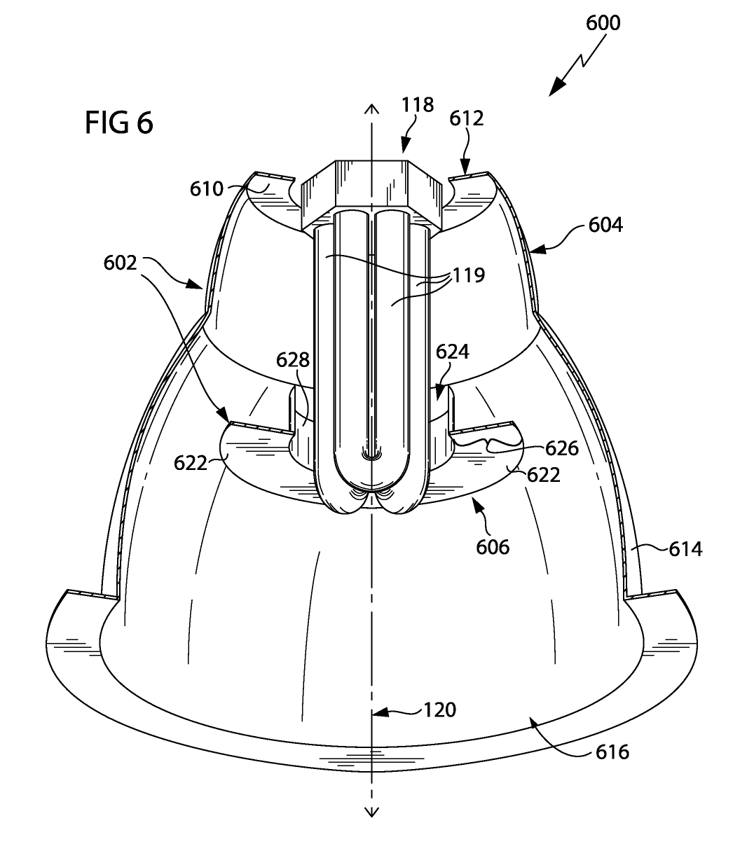

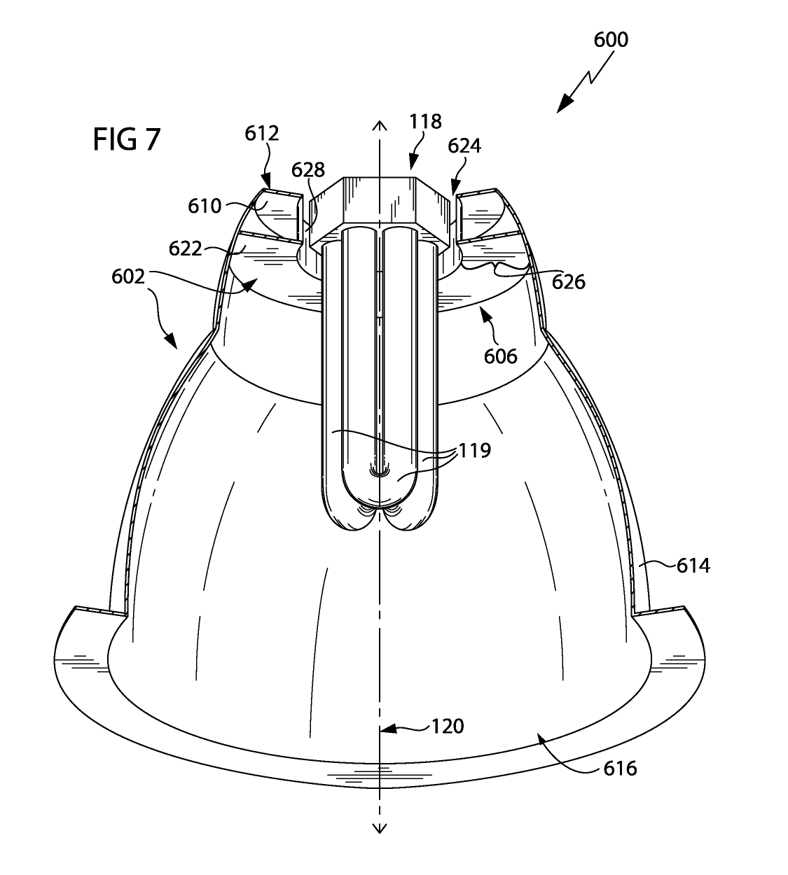

FIGS. 6-7 depict another embodiment of a lighting fixture 600 having a reflector assembly consistent 602 with the present invention. The reflector assembly 602 includes a primary reflector 604 and a secondary reflector 606. The primary reflector 604 is pre-formed to have a final shape consistent with the primary reflector 104 using standard fabrication processes (e.g., hydroforming, deep draw, spinning about a chuck or die, or other process) and then polished and anodized using a standard anodizing technique (such as an ALZAK™ anodizing technique) so that a first inner surface 610 of the primary reflector 604 has a specular finish with a reflectivity value up to 87%. As shown in FIGS. 6-7, the primary reflector 604 has a top wall 612 having the first inner surface 610 and a side wall 614 extending from the top wall 612 and defining an open end 616 of the primary reflector 604. Consistent with the primary reflector 104 depicted in FIGS. 1-3, the primary reflector 604 may be pre-formed so that the inner surface 610 of the reflector 604 integrally extends from the top wall 612 down along the side wall 614 towards the open end 616 of the reflector. In this implementation, the inner surface 610 of the top wall 612 and side wall 614 may be polished and anodized to have a specular finish with a reflectivity value up to 87%.

However, in the implementation shown in FIGS. 6-7, the primary reflector 604 is adapted to receive a lamp package 118 having one or more lamps 119, such that the lamp package 118 is disposed at least partially within and substantially parallel to the vertical axis 120 of the primary reflector 602 and at least partially below the secondary reflector 606.

The secondary reflector 606 has a second inner surface 622, which has a second reflectivity value that is greater than the first reflectivity value of the first inner surface 610 of the primary reflector 604. In this implementation, the secondary reflector 606 is formed consistent with the secondary reflector 106 from a pre-finished material, such as a MIRO® material commercially available from Alanod Aluminum-Veredlung GmbH & Co. KG, that has a specular surface (i.e., the second inner surface 622) with a reflectivity equal to or greater than 95 percent before and after the formation of the secondary reflector 606. In one implementation, the secondary reflector 606 has a structure consistent with the secondary reflector 106 as depicted in FIG. 4.

To avoid cracking or crazing of the second inner surface 622 and degradation of the 95% or greater reflectivity of the specular inner surface 622 during formation of the secondary reflector 606, the secondary reflector 606 is stamped or formed to have a substantially flat shape and having a cutout 624 using a standard fabrication process that does not require stretching or folding the pre-finished material in more than one direction simultaneously. The cutout 624 is of sufficient size to allow the lamp package 118 to be received through the cutout 624 as shown in FIGS. 6 and 7. In one implementation, the secondary reflector 606 may have a substantially flat disc portion 626 and an inner collar portion 628 extending substantially vertically from the disc portion and defining the cutout 624. In the implementation shown in FIGS. 6 and 7, at least the flat disc portion 626 has the specular inner surface 622, which is not crazed or cracked because the flat disc portion 626 is not subjected to hydroforming, deep draw, spinning about a chuck or die, or other process that requires the second inner surface 622 to be stretched or folded in more than one direction substantially simultaneously.

As shown in FIG. 7, the secondary reflector 606 is disposed within the primary reflector 604 or relative to the first inner surface 610 of the top wall 612 and at least partially above the lamp package 118 such that light from the light package 118 directed to the first inner surface 610 of the top wall 612 is substantially reflected by the second inner surface 622 of the secondary reflector 606 towards the open end 616 of the primary reflector 604. Although not shown in the figures, one of ordinary skill in the art will appreciate that the inner collar portion 628 may be used to affix or fasten the secondary reflector 606 to the lighting fixture 600 to maintain the second inner surface 622 of the secondary reflector 606 relative to the first inner surface 610 of the primary reflector 604. The reflector assembly 602 used in a light fixture 600 having a vertically installed lamp package 118 exhibits substantially increased lamp light reflectance efficiency (consistent with the reflector assembly 102 as shown in FIGS. 5A-5C) over other conventional one or two piece reflectors for light fixtures.

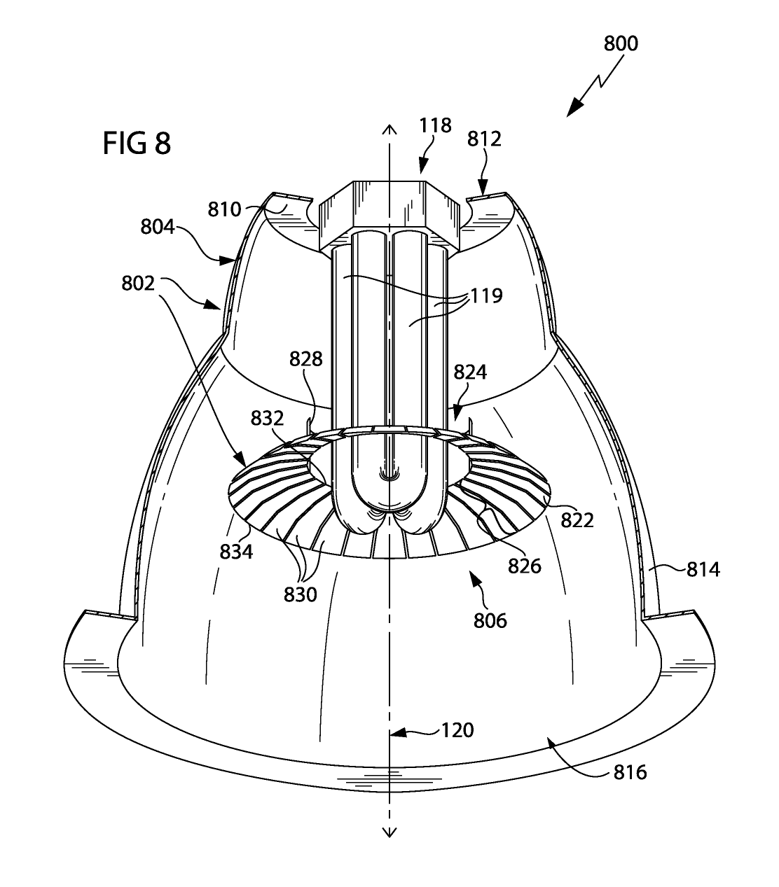

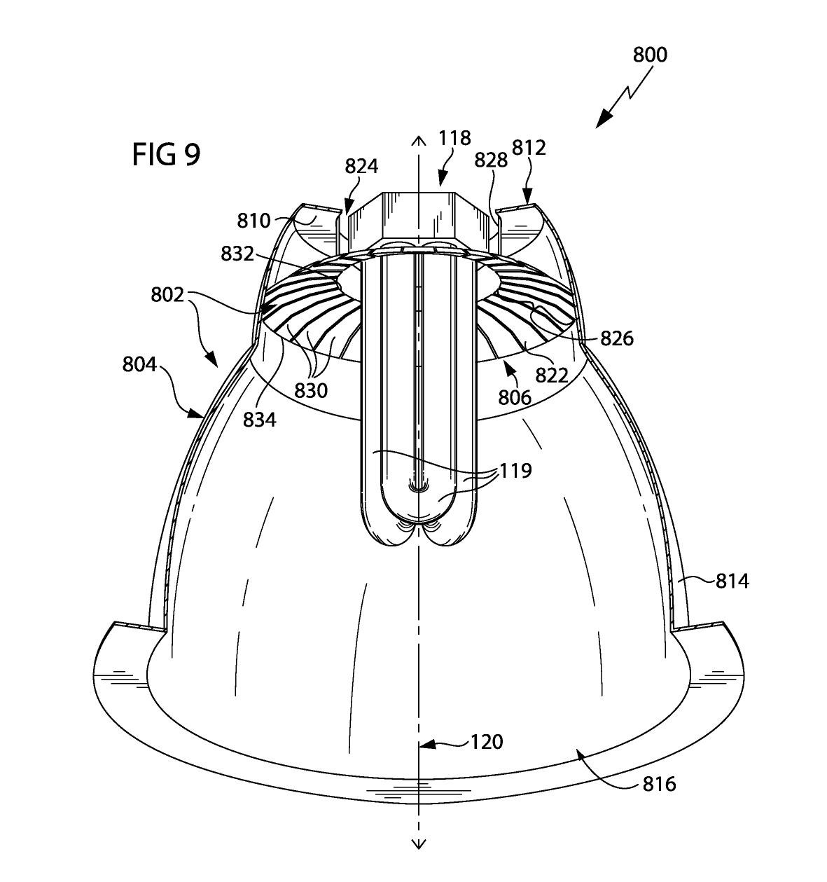

FIGS. 8-9 depict another embodiment of a lighting fixture 800 having a reflector assembly consistent 802 with the present invention. The reflector assembly 802 includes a primary reflector 804 and a secondary reflector 806. The primary reflector 804 is pre-formed to have a final shape, consistent with the primary reflector 104 in FIGS. 1-3 and primary reflector 604 in FIGS. 6-7, using standard fabrication processes (e.g., hydroforming, deep draw, spinning about a chuck or die, or other process) and then polished and anodized using a standard anodizing technique (such as an ALZAK™ anodizing technique) so that a first inner surface 810 of the primary reflector 804 has a specular finish with a reflectivity value up to 87%. As shown in FIGS. 8-9, the primary reflector 804 has a top wall 812 having the first inner surface 810 and a side wall 814 extending from the top wall 812 and defining an open end 816 of the primary reflector 804. The primary reflector 804 may be pre-formed so that the inner surface 810 of the reflector 804 integrally extends from the top wall 812 down along the side wall 814 towards the open end 816 of the reflector. In this implementation, the inner surface 810 of the top wall 812 and side wall 814 may be polished and anodized to have a specular finish with a reflectivity value up to 87%.

Consistent with the primary reflector 604 depicted in FIGS. 6-7, the primary reflector 804 is adapted to receive a lamp package 118 having one or more lamps 119, such that the lamp package 118 is disposed at least partially within and substantially parallel to the vertical axis 120 of the primary reflector 802 and at least partially below the secondary reflector 806.

The secondary reflector 806 has a second inner surface 822, which has a second reflectivity value that is greater than the first reflectivity value of the first inner surface 810 of the primary reflector 804. In this implementation, the secondary reflector 806 is formed consistent with the secondary reflectors 106 and 606 from a pre-finished material, such as a MIRO® material commercially available from Alanod Aluminum-Veredlung GmbH & Co. KG, that has a specular surface (i.e., the second inner surface 822) with a reflectivity equal to or greater than 95 percent before and after the formation of the secondary reflector 806. In one implementation, the secondary reflector 806 has a structure consistent with the secondary reflector 106 as depicted in FIG. 4.

To avoid cracking or crazing of the second inner surface 822 and degradation of the 95% or greater reflectivity of the specular inner surface 822 during formation of the secondary reflector 806, the secondary reflector 806 is stamped or formed to have a concave shape and having a cutout 824 using a standard fabrication process that does not require stretching or folding the pre-finished material in more than one direction simultaneously. The cutout 824 is of sufficient size to allow the lamp package 118 to be received through the cutout 824 as shown in FIGS. 6 and 7. In one implementation, the secondary reflector 806 may have a substantially a concave portion 826 and an inner collar portion 828 extending substantially vertically from the disc portion and defining the cutout 824. In this implementation, the concave portion 826 comprises a plurality of finger sections 830 stamped or formed in flat stock of the pre-finished material (e.g., having a structure as depicted in FIG. 4) such that each finger section 830 has an annular inner edge 832 having a first width and an annular outer edge 834 having a second width that is greater than the first width. The finger sections are then aligned side by side (and affixed to each other if necessary) so that the inner edge 832 of each finger section 830 is aligned with the inner edge 832 of an adjacent finger section 830 to form a cone shape corresponding to the concave portion 826. In this implementation, the finger sections 830 collectively form the specular inner surface 622 of the concave portion 826 in accordance with the present invention.

As shown in FIG. 9, the secondary reflector 806 is disposed within the primary reflector 804 or relative to the first inner surface 810 of the top wall 812 and at least partially above the lamp package 118 such that light from the light package 118 directed to the first inner surface 810 of the top wall 812 is substantially reflected by the second inner surface 822 of the secondary reflector 806 towards the open end 816 of the primary reflector 804. Although not shown in the figures, one of ordinary skill in the art will appreciate that the inner collar portion 828 may be used to affix or fasten the secondary reflector 806 to the primary reflector 804 of the lighting fixture 800 to maintain the second inner surface 822 of the secondary reflector 806 relative to the first inner surface 810 of the primary reflector 804. The reflector assembly 802 used in a light fixture 800 having a vertically installed lamp package 118 exhibits substantially increased lamp light reflectance efficiency (consistent with the reflector assembly 102 as shown in FIGS. 5A-5C) over other conventional one or two piece reflectors for light fixtures. In addition, the concave portion 826 is adapted to further increase light intensity reflected towards the open end 816 of the primary reflector 804.

While various embodiments of the present invention have been described, it will be apparent to those of skill in the art that many more embodiments and implementations are possible that are within the scope of this invention. Accordingly, the present invention is not to be restricted except in light of the attached claims and their equivalents.

What is claimed is:

1. A reflector assembly for use in a lighting fixture, comprising:
a primary reflector adapted to mate to the lighting fixture and including a first inner surface having a first reflectivity value; and
a secondary reflector disposed within the primary reflector and including a second inner surface having a second reflectivity value that is greater than the first reflectivity value.

2. The reflector assembly of claim 1, wherein the first reflectivity value is equal to or less than 87 percent.

3. The reflector assembly of claim 1, wherein the second reflectivity value is equal to or greater than 95 percent.

4. The reflector assembly of claim 1, wherein the primary reflector is adapted to receive a lamp package such that the lamp package is disposed at least partially within and at an angle relative to a vertical axis of the primary reflector and at least partially below the secondary reflector.

5. The reflector assembly of claim 4, wherein the lamp package is disposed substantially perpendicular to the vertical axis of the primary reflector.

6. The reflector assembly of claim 4, wherein the primary reflector has a top wall having the first inner surface and a side wall extending from the top wall and defining an open end of the primary reflector, and the secondary reflector is disposed relative to the first inner surface of the top wall such that light from the light package directed to the first inner surface of the top wall is substantially reflected by the second inner surface of the secondary reflector towards the open end of the primary reflector.

7. The reflector assembly of claim 1, wherein the primary reflector is adapted to receive a lamp package such that the lamp package is disposed at least partially within and substantially parallel to a vertical axis of the primary reflector and at least partially below the secondary reflector.

8. The reflector assembly of claim 7, wherein the primary reflector has a top wall having the first inner surface and a side wall extending from the top wall and defining an open end of the primary reflector, and the secondary reflector is disposed relative to the first inner surface of the top wall such that light from the light package directed to the first inner surface of the top wall is substantially reflected by the second inner surface of the secondary reflector towards the open end of the primary reflector.

9. The reflector assembly of claim 8, wherein the secondary reflector is formed from a pre-finished material having the second inner surface so that the second inner surface has a concave shape.

10. The reflector assembly of claim 9, wherein the second reflectivity of the second inner surface of the pre-finished material is equal to or greater than 95 percent before and after the formation of the secondary reflector.

11. The reflector assembly of claim 1, wherein the secondary reflector is formed from a pre-finished material having the second inner surface, the second reflectivity of the second inner surface being equal to or greater than 95 percent.

12. The reflector assembly of claim 11, wherein the pre-finished material comprises an anodized aluminum substrate, a first layer formed over the substrate and having aluminum of 99.7% or greater purity, a second layer formed over the first layer and having Silicium, and a third layer formed over the second layer and having Titanium.

13. The reflector assembly of claim 12, wherein the second layer and the third layer have a collective thickness equal to or less than 80 nm.

14. The reflector assembly of claim 11, wherein the pre-finished material is a MIRO® material.

15. The reflector assembly of claim 1, wherein the first inner surface of the primary reflector has a finish formed via an aluminum anodizing technique.

16. The reflector assembly of claim 15, wherein the anodizing technique is an ALZAK™ anodizing technique.

17. A method for improving the optical efficiency of a light fixture, the light fixture having a primary reflector adapted to mate to the lighting fixture and including a first inner surface having a first reflectivity value, the method comprising:
forming a secondary reflector having a second reflectivity value that is greater than the first reflectivity value of the primary reflector; and
disposing the secondary reflector in proximity to the first inner surface of the primary reflector.

18. The method of claim 17, wherein the first reflectivity value is equal to or less than 87 percent.

19. The method of claim 17, wherein the second reflectivity value is equal to or greater than 95 percent.

20. The method of claim 17, wherein the primary reflector is adapted to receive a lamp package such that the lamp package is disposed at least partially within and at an angle relative to a vertical axis of the primary reflector and the step of disposing comprises disposing the secondary reflector at least partially between the lamp package and the first inner surface of the primary reflector.

21. The method of claim 20, wherein the primary reflector has a top wall having the first inner surface and a side wall extending from the top wall and defining an open end of the primary reflector, and the secondary reflector is disposed between the first inner surface of the top wall and the lamp package such that light from the light package directed to the first inner surface of the top wall is substantially reflected by the second inner surface of the secondary reflector towards the open end of the primary reflector.

22. The method of claim 17, wherein the primary reflector is adapted to receive a lamp package such that the lamp package is disposed at least partially within and substantially parallel to a vertical axis of the primary reflector and the step of disposing comprises disposing the secondary reflector at least partially between the lamp package and the first inner surface of the primary reflector.

23. The method of claim 22, wherein the primary reflector has a top wall having the first inner surface and a side wall extending from the top wall and defining an open end of the primary reflector, and the secondary reflector is disposed between the first inner surface of the top wall and the lamp package such that light from the light package directed to the first inner surface of the top wall is substantially reflected by the second inner surface of the secondary reflector towards the open end of the primary reflector.

24. The method of claim 23, wherein the secondary reflector is formed from a pre-finished material having the second inner surface so that the second inner surface has a concave shape.

25. The method of claim 24, wherein the second reflectivity of the second inner surface of the pre-finished material is equal to or greater than 95 percent before and after the formation of the secondary reflector.

26. The method of claim 17, wherein the secondary reflector is formed from a pre-finished material having the second inner surface, the second reflectivity of the second inner surface being equal to or greater than 95 percent.

27. The method of claim 26, wherein the pre-finished material comprises an anodized aluminum substrate, a first layer formed over the substrate and having aluminum of 99.7% or greater purity, a second layer formed over the first layer and having Silicium, and a third layer formed over the second layer and having Titanium.

28. The method of claim 27, wherein the second layer and the third layer have a collective thickness equal to or less than 80 nm.

29. The method of claim 26, wherein the pre-finished material is a MIRO® material.

30. The method of claim 17, wherein the first inner surface of the primary reflector has a finish formed via an aluminum anodizing technique.

31. The method of claim 31, wherein the anodizing technique is an ALZAK™ anodizing technique.
